(19) United States
(12) Patent Application Publication
(10) Pub. No.: US 2023/0205940 A1
(43) Pub. Date: Jun. 29, 2023

(54) THREE-DIMENSIONAL SPACE DESIGN APPARATUS AND METHOD

(71) Applicant: PlantStream Inc., Tokyo (JP)

(72) Inventors: Seitaro NARUE, Yokohama-shi (JP); Ken TSUCHIHASHI, Yokohama-shi (JP); Fumiaki SAKAI, Yokohama-shi (JP); Naohisa OHKITA, Tokyo (JP); Takashi NAKAGAWA, Tokyo (JP)

(73) Assignee: PlantStream Inc., Tokyo (JP)

(21) Appl. No.: 18/177,224

(22) Filed: Mar. 2, 2023

Related U.S. Application Data
(63) Continuation of application No. PCT/JP2021/032282, filed on Sep. 2, 2021.

(30) Foreign Application Priority Data
Sep. 3, 2020 (JP) 2020-148543

(51) Int. Cl. G06F 30/13; G06F 30/17; G06F 30/12

(52) U.S. Cl. CPC G06F 30/13; G06F 30/17; G06F 30/12; G06F 2113/14

(57) ABSTRACT

A server (20) of a plant design system (1) includes a device input reception module (2033) for receiving an input operation (object allocation operation) for a type and allocation position of a block pattern or device to be allocated in a virtual space for plant design, a device allocation module (2034) for displaying a display based on information of the type and allocation position of the block pattern or device, and a pipe routing module (2037) for receiving an instruction operation (routing operation) to associate routing of piping with the block pattern or device and perform routing.

### CROSS-REFERENCE TO RELATED APPLICATION

This application is based upon and claims the benefit of priority from PCT Patent Application No. PCT/JP2021/032282, the entire contents all of which are incorporated herein by reference.

### FIELD

Embodiments described herein relate generally to a three-dimensional space design apparatus, and a method.

### BACKGROUND

In order to construct a large facility such as a chemical plant, various facilities and devices are placed at appropriate locations, and pipe routing for various fluids is performed. Such piping is, for example, disposed within the plant for transporting source gas or exhaust gas through the plant. The pipe routing performed at the plant design stage requires consideration of various factors, such as the functional requirements of the plant, conditions such as the type of fluid and temperature, and maintainability; and this requires extensive work. To assist in such operations, design tools such as CAD are used, and various designs have been created in this manner for device placement, pipe routing, and the like.

it is known that technology for a piping route generating apparatus used in the plant design stage. This technology improves the efficiency of the processing for automatically determining the piping routes, allowing the position of the piping routes to be adjusted using an alignment guide representing the target position of the pipes, a plurality of piping routes to be aligned, interference between pipes to be avoided, and the interval between pipes to be constant.

However, pipe routing in the design of a facility such as a chemical plant involves determining routes between various types of devices, such as pumps and heat exchangers. In regard to pipe routing, in a case of routing near connection points to various devices, it is very difficult to determine the shortest route that also avoids the effects of the devices, and the designer's experience and preferences also play a large factor. Thus, general systems for automatically generating piping routes have not been able to perform as hoped. However, using a known design tool such as CAD to design all of the piping routes by hand (manually) requires a great amount of time and effort.

### SUMMARY

In order to solve this problem, the present disclosure describes a technology capable of easily performing routing processing for connecting pipes to various devices.

### BRIEF DESCRIPTION OF DRAWINGS

FIG. 1 is an appearance view illustrating an example of a block pattern according to a plant design system.

FIG. 2 is a diagram illustrating the overall configuration of a plant design system 1.

FIG. 3 is a block diagram illustrating a functional configuration of a terminal apparatus 10 constituting the plant design system 1 of the first embodiment.

FIG. 4 is a diagram illustrating a functional configuration of a server 20 constituting the plant design system 1 of the first embodiment.

FIG. 5 is an appearance view illustrating an example of a pump that can be edited via the plant design system 1 of the first embodiment.

FIG. 6 is an appearance view illustrating an example of a heat exchanger that can be edited via the plant design system 1 of the first embodiment.

FIG. 7 is an appearance view illustrating an example of a filter that can be edited via the plant design system 1 of the first embodiment.

FIG. 8 is an appearance view illustrating an example of a valve that can be edited via the plant design system 1 of the first embodiment.

FIG. 9 is a diagram illustrating the data structure of a device database 2021, a parameter database 2022, and a design space database 2023 stored by the server 20.

FIG. 10 is a flowchart illustrating an example of the flow of edit processing of a block pattern or a device by the plant design system 1 of the first embodiment.

FIG. 11 is a flowchart illustrating an example of the flow of piping route determination processing performed by the plant design system 1 of the first embodiment.

FIG. 12 is a diagram illustrating an example of a screen of the terminal apparatus 10 displaying space in an initial state.

FIG. 13 is a diagram illustrating an example of a screen of the terminal apparatus 10 for block pattern editing.

FIG. 14 is a diagram illustrating an example of a screen of the terminal apparatus 10 displaying a piping route.

### DETAILED DESCRIPTION

In general, according to one embodiment, A three-dimensional space design apparatus provided with a processing circuitry configured to execute processing relating to three-dimensional space design of a plant, wherein

the processing circuitry executes:

receiving from a user an object allocation operation for designating a position in a virtual space to allocate a first object, which is an object in which a pipe is preset for a device constituting the plant;

allocating the first object in the virtual space in response to the object allocation operation from a user;

receiving a routing operation from a user; and

performing pipe routing for connection to an end of the pipe of the allocated first object in response to the routing operation.

Embodiments of the present disclosure will be described below with reference to the drawings. In the following description, identical components are given the same reference symbols. The names and functions are also the same. Thus, a detailed description of these components will not be repeated.

A summary of plant design and a plant design system according to the present disclosure will be described below. This plant design system is a system for designing facility groups for producing chemical products via various production processes through chemical reactions, such as for liquefied natural gas (LNG) plants or petrochemical plants. Examples of facilities placed in a plant include, in a case of an LNG plant, an acid gas removal facility for removing acid gas (H₂S, CO₂, organic sulfur, and the like) contained in the source gas that is to undergo liquefaction processing, a sulfur recovery facility for recovering elemental sulfur from the removed acid gas, a moisture removal facility for removing moisture contained in the source gas, and a compression facility for a refrigerant (mixed refrigerant, propane refrigerant, or the like) used for cooling and liquefying the source gas. Herein, “plant facility” refers to a group of equipment or a group of devices installed according to the purpose of the plant.

The design of such a plant includes, for example, the following steps. First, the placement of various facilities within the plant, the placement of various devices such as pumps and heat exchangers, and the placement of frame structures (piping racks) for routing various pipes are determined and main piping routes are determined. Then, the plant layout is designed, and a layout diagram called a plot plan is created. Next, on the basis of the functional requirements of the entire plant, process units (a series of manufacturing steps) from receiving the raw materials used in the plant to product shipment are defined in detail, material/heat balance calculations are performed for each process, and a process flow called a process flow diagram (PFD) is created. Furthermore, on the basis of the PFD, simulations are repeated to modify process calculations, the layout of the piping (pipe routing) running through each device in the plant is determined, and a detailed instrument diagram called a piping and instrument diagram (P&ID) is created. The plant design system according to the present disclosure is a 3D CAD system for assisting in the layout designing of devices in the entire plant and each facility, the process flow creation, the pipe routing, the P&ID, and the like at each step as described above.

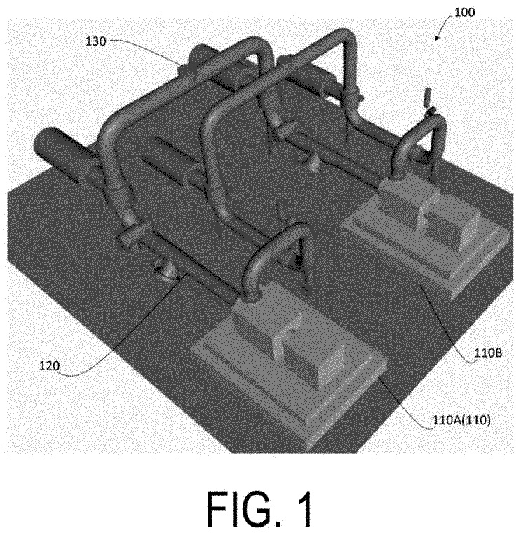

FIG. 1 is an appearance view illustrating an example of a block pattern according to a plant design system according to the present disclosure. A block pattern (first object) 100 illustrated in FIG. 1 is an object including devices constituting a plant in each facility of the plant with the pipes allocated in advance. Note that in the block pattern 100, with the devices constituting the plant, in addition to the pipes, other devices may also be allocated in advance. Specific examples of devices constituting the plant include a pump, a heat exchanger, a filter, and a valve. In addition, the pipes and other devices that are allocated in advance in the block pattern are referred to as installed pipes and installed devices, respectively. Herein, “installed pipe” refers to a pipe arranged around a device and provided with an intake and an outlet (also called a suction pipe and a discharge pipe) for the fluid used in the device. “Installed device” refers to, for example, an instrumentation device such as a valve or flow meter disposed in advance in the vicinity of the device or in the installed pipe. In the block pattern 100 illustrated in FIG. 1, a pump is used as an example of such a device, and the block pattern 100 includes one or a plurality of pumps (two pumps, a pump 110A and a pump 110B, in FIG. 1, hereinafter also collectively referred to as “pumps 110”), an installed pipe 120, and a connection portion 130.

As illustrated in FIG. 1, the block pattern 100 is an object in which the pump 110A and the pump 110B are allocated as an example of one or a plurality of devices, and pipes and devices are allocated in advance on the devices constituting the plant within each of the facilities of the plant. A plurality of such block patterns are prepared for each type of device and for each functional requirement indicated in the P&ID described above, for example, the number of devices, valve arrangements, the number of valves, and the like. In addition, the block pattern is configured so that parameters, such as the length of the installed pipe 120, the angle of connection with the pumps 110, and the position and angle of the connection portion 130, can be edited. With a plant design such as the one described above, the block pattern 100 is placed in a virtual space for performing plant design, where various edits are made and pipe routing between the connection portion 130 and other devices is performed.

As noted above, pipe routing in plant designs is difficult in terms of routing near connection points to various devices, and different designers' experience and preferences often result in different designs. Accordingly, while various technologies for performing automatic routing have been proposed in the field of 3D CAD systems, acceptable performance in terms of routing near connection points to various devices has not been achieved. Also, as with conventional CAD systems, designing all of the piping routes by hand (manually) requires a great amount of time and effort.

Thus, in the plant design system according to the present disclosure, a plurality of the block patterns 100 illustrated in FIG. 1 are prepared for each functional requirement, pipes are allocated in advance near connection points to devices (around the devices), and various edits to the parameters of the devices, piping, and the like can be performed. With the pipe routing near connection points to devices (around devices), it is very difficult to determine the shortest route while avoiding the effects of the devices, and the designer's experience and preferences also play a large factor due to this difficulty. A user performing plant design selects a plurality of patterns of the block pattern 100 in accordance with the functional requirements of the plant, places these in a virtual space, and edits the parameters to optimize the block pattern 100. Note that the user can select not only a block pattern but also an individual device (second object) such as a pump or a heat exchanger, allocate this in the virtual space, and edit the parameters of the device. Next, a section such as the connection portion 130 is designated as a starting location or an ending location of the pipe routing, and pipe routing is performed. With a plant design system configured as such, routing near connection points to devices (around the devices), i.e., difficult pipe routing, can be easily performed.

### First Embodiment

A plant design system 1 will be described below. In the following description, for example, when the terminal apparatus 10 accesses a server 20, the server 20 replies with information for generating a screen on the terminal apparatus 10. The terminal apparatus 10 generates and displays a screen based on the information received from the server 20.

1. Overall Configuration of Plant Design System 1

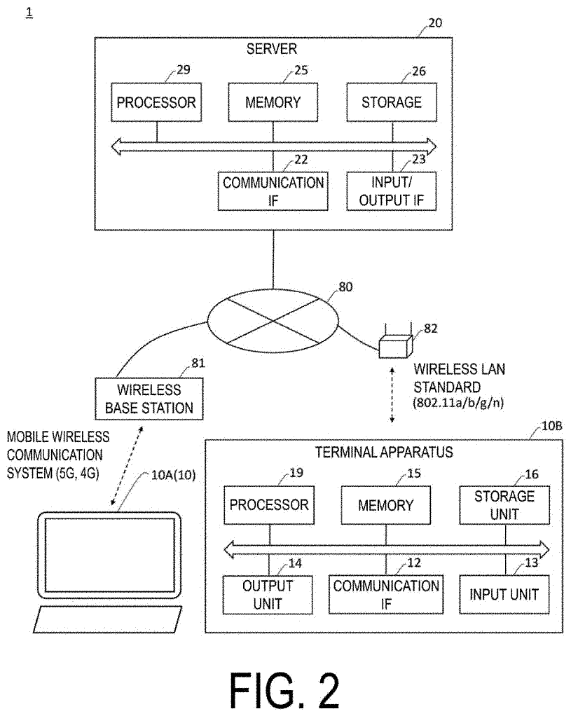

FIG. 2 is a diagram illustrating the overall configuration of the plant design system 1. As illustrated in FIG. 2, the plant design system 1 includes a plurality of terminal apparatuses (a terminal apparatus 10A and a terminal apparatus 10B in FIG. 2, hereinafter also collectively referred to as “terminal apparatuses 10”) and the server 20. The terminal apparatuses 10 and the server 20 are communicatively connected to one another via a network 80. The network 80 is constituted by a wired or wireless network.

The terminal apparatuses 10 are apparatuses to be operated by a user. Herein, “user” refers to a person performing plant design, which is a function of the plant design system 1, using the terminal apparatus 10. The terminal apparatus 10 is implemented by a non-portable personal computer (PC), a laptop PC, or the like. In addition, the terminal apparatus 10 may be a tablet, a smart phone, or other such portable device compatible with a mobile communication system, for example.

The terminal apparatuses 10 are communicatively connected to the server 20 via the network 80. The terminal apparatuses 10 are connected to the network 80 via communication with communication apparatuses such as a wireless base station 81 compliant with a communication standard such as 5G or long term evolution (LTE), or a wireless local area network (LAN) router 82 compliant with a wireless LAN standard such as institute of electrical and electronics engineers (IEEE) 802.11. As illustrated in FIG. 2 by the terminal apparatus 10B, the terminal apparatuses 10 each include a communication interface (IF) 12, an input unit 13, an output unit 14, a memory 15, a storage unit 16, and a processor 19.

The communication IF 12 is an interface for inputting and outputting signals for establishing communication between the terminal apparatus 10 and an external apparatus. The input unit 13 is an input unit (for example, a keyboard, a touch panel, a touch pad, a pointing device such as a mouse, or the like) for receiving an input operation from a user. The output unit 14 is an output unit (a display, a speaker, or the like) for presenting information to a user. The memory 15 is a volatile memory such as a dynamic random access memory (DRAM) for temporarily storing programs, data to be processed by programs, and the like. The storage unit 16 is a storage unit for storing data and is, for example, a flash memory, a hard disc drive (HDD), or the like. The processor 19 is hardware for executing the set of commands described in the program, and is constituted by an arithmetic apparatus, a processor register, a peripheral circuit, or the like.

The server 20 is an apparatus that manages information of each user, information of the block pattern or devices, and information of the designed virtual space (including designs in progress). The server 20 receives a user input, such as an instruction relating to the type of the block pattern or device to be allocated in the virtual space for plant design, the allocation position, pipe routing, and the like. Specifically, for example, the viewpoint (virtual camera) in the virtual space for plant design is set, rendering of a block pattern or various devices and routed pipes allocated according to a user instruction is performed on the basis of the virtual camera setting, and the result is displayed on the terminal apparatus 10. The server 20 places objects in the virtual space on the basis of the type of the block pattern or device and the allocation position that are input, determines the piping route on the basis of a user instruction to perform pipe routing and performs routing in the virtual space, and displays the result on the terminal of the user. Examples of devices able to be used in the virtual space include various facilities used in a chemical plant. Specific examples include pumps, heat exchangers, filters, valves, piping members, instruments, heating furnaces, tower tanks, and agitators. The device is not limited to these, and other facilities may be included.

The server 20 is a computer connected to the network 80. The server 20 includes a communication IF 22, an input/output IF 23, a memory 25, a storage 26, and a processor 29.

The communication IF 22 is an interface for inputting and outputting signals for establishing communication between the server 20 and an external apparatus. The input/output IF 23 functions as an interface with an input unit for receiving input operations from a user and an output unit for presenting information to a user. The memory 25 is a volatile memory such as a DRAM for temporarily storing programs, data to be processed by programs, and the like. The storage 26 is a storage unit for storing data and is, for example, flash memory, an HDD, or the like. The processor 29 is hardware for executing the set of commands described in the program, and is constituted by an arithmetic apparatus, a processor register, a peripheral circuit, or the like.

1.1. Configuration of Terminal Apparatus 10

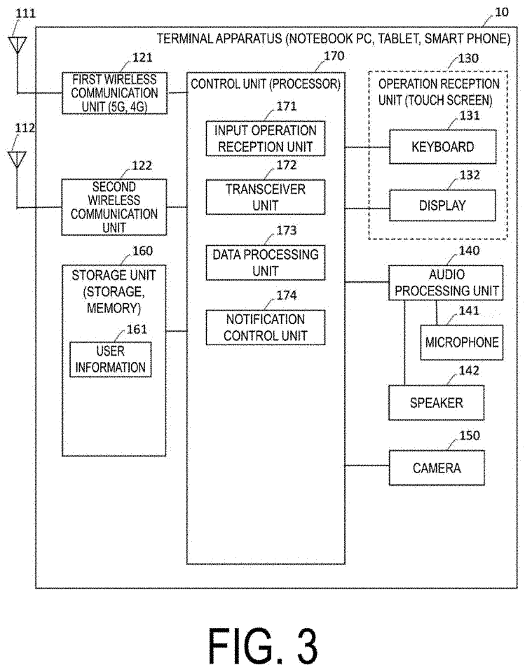

FIG. 3 is a block diagram illustrating a functional configuration of the terminal apparatus 10 constituting the plant design system 1 of the first embodiment. As illustrated in FIG. 3, the terminal apparatus 10 includes a plurality of antennas (an antenna 111 and an antenna 112), wireless communication units (a first wireless communication unit 121 and a second wireless communication unit 122) respectively corresponding to the plurality of antennas, an operation reception unit 130 (including a keyboard 131 and a display 132), an audio processing unit 140, a microphone 141, a speaker 142, a camera 150, a storage unit 160, and a control unit 170. The terminal apparatus 10 also includes functions and configurations not specifically illustrated in FIG. 3 (for example, a battery for holding power, a power supply circuit for controlling the supply of power from the battery to the circuits, and the like). As illustrated in FIG. 3, each block included in the terminal apparatus 10 is electrically connected by a bus or the like.

The antenna 111 emits a signal to be transmitted by the terminal apparatus 10 as a radio wave. The antenna 111 receives radio waves from the space and sends the received signal to the first wireless communication unit 121.

The antenna 112 emits a signal to be transmitted by the terminal apparatus 10 as a radio wave. The antenna 112 receives radio waves from the space and sends the received signal to the second wireless communication unit 122.

Because the terminal apparatus 10 communicates with the other wireless apparatuses, the first wireless communication unit 121 executes modulation/demodulation processing for transmitting and receiving signals via the antenna 111. Because the terminal apparatus 10 communicates with the other wireless apparatuses, the second wireless communication unit 122 executes modulation/demodulation processing for transmitting and receiving signals via the antenna 112. The first wireless communication unit 121 and the second wireless communication unit 122 are communication modules including a tuner, a received signal strength indicator (RSSI) calculation circuit, a cyclic redundancy check (CRC) calculation circuit, a high-frequency circuit, and the like. The first wireless communication unit 121 and the second wireless communication unit 122 perform modulation/demodulation and frequency conversion of wireless signals transmitted and received by the terminal apparatus 10, and supply the received signals to the control unit 170.

The operation reception unit 130 includes a mechanism for receiving a user input operation. Specifically, the operation reception unit 130 includes the keyboard 131 and the display 132. Note that the operation reception unit 130 may be configured as a touch screen that detects a position at which the user makes contact with the touch panel by using, for example, a capacitive touch panel.

The keyboard 131 receives an input operation of a user of the terminal apparatus 10. The keyboard 131 is a unit for inputting characters and outputting the input character information to the control unit 170 as an input signal.

The display 132 displays data such as images, video, and text in response to control by the control unit 170. The display 132 is implemented by, for example, a liquid crystal display (LCD) or an electroluminescent (EL) display.

The audio processing unit 140 performs modulation/demodulation of an audio signal. The audio processing unit 140 modulates the signal from the microphone 141 and sends the modulated signal to the control unit 170. The audio processing unit 140 also sends audio signals to the speaker 142. The audio processing unit 140 is implemented by, for example, a processor for audio processing. The microphone 141 receives the audio input and sends audio signals corresponding to the audio input to the audio processing unit 140. The speaker 142 converts the audio signal from the audio processing unit 140 to audio and outputs the audio out of the terminal apparatus 10.

The camera 150 is a device for receiving light via a photodetector and outputting a captured image. The camera 150 is, for example, a depth camera capable of detecting distance from the camera 150 to the object to be captured.

The storage unit 160 is constituted by, for example, a flash memory or the like and stores data and programs used by the terminal apparatus 10. In some aspects, the storage unit 160 stores user information 161.

The user information 161 is information of a user performing plant design, which is a function of the plant design system 1, using the terminal apparatus 10. The user information includes information identifying a user (user ID), name of the user, organization information such as that of the company the user is employed by, or the like.

The control unit 170 controls the operation of the terminal apparatus 10 by reading a program stored in the storage unit 160 and executing commands included in the program. The control unit 170 is an application which is, for example, installed in the terminal apparatus 10 in advance. The control unit 170 functions as an input operation reception unit 171, a transceiver unit 172, a data processing unit 173, and a notification control unit 174 by operating in accordance with a program.

The input operation reception unit 171 executes processing to receive a user input operation made to an input unit such as the keyboard 131.

The transceiver unit 172 executes processing to transmit and receive data between the terminal apparatus 10 and an external apparatus such as the server 20 according to a communication protocol.

The data processing unit 173 executes processing to perform calculations on the data received by the terminal apparatus 10 according to a program and output the calculation result to a memory or the like.

The notification control unit 174 executes processing to present information to the user. The notification control unit 174 executes processing to display a display image on the display 132, processing to output audio to the speaker 142, processing to make the camera 150 vibrate, and the like.

1.2. Functional Configuration of Server 20

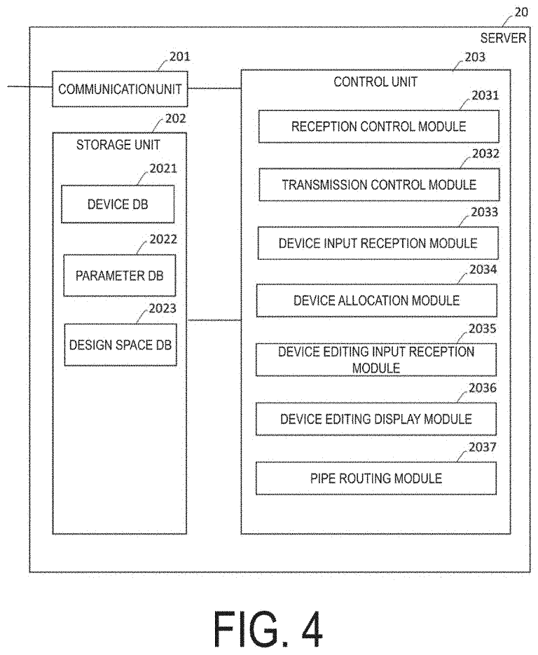

FIG. 4 is a diagram illustrating a functional configuration of the server 20 constituting the plant design system 1 of the first embodiment. As illustrated in FIG. 4, the server 20 functions as a communication unit 201, a storage unit 202, and a control unit 203.

The communication unit 201 executes processing for the server 20 to establish communication with an external apparatus.

The storage unit 202 stores data and programs used by the server 20. The storage unit 202 stores a device database 2021, a parameter database 2022, a design space database 2023, and the like.

The device database 2021 is a database for storing information of block patterns or various devices to be allocated in a virtual space presented for plant design in the plant design system 1. Details will be described below.

The parameter database 2022 is a database for storing information of parameters for editing block patterns or various devices allocated in a virtual space presented for plant design in the plant design system 1. Details will be described below.

The design space database 2023 is a database for storing information of the virtual space where a user has performed design. Details will be described below.

The control unit 203 functions as modules including a reception control module 2031, a transmission control module 2032, a device input reception module 2033, a device allocation module 2034, a device editing input reception module 2035, a device editing display module 2036, and a pipe routing module 2037, by a processor of the server 20 executing processing in accordance with a program.

The reception control module 2031 controls processing for the server 20 to receive signals from an external apparatus according to a communication protocol.

The transmission control module 2032 controls the processing for the server 20 to transmit signals to an external apparatus according to a communication protocol.

The device input reception module 2033 controls the processing for receiving from a user an input operation (object allocation operation) of the type of a block pattern (first object) or device (second object) to be allocated in the virtual space and the allocation position in the virtual space for plant design using the plant design system 1. When a user uses the terminal apparatus 10 to perform the plant design, a virtual space that simulates the actual location for performing plant design is displayed on the display 132 of the terminal apparatus 10. Thereafter, the user inputs the type of block pattern or device to be allocated in the virtual space and the allocation position in the virtual space by performing a predetermined operation on the screen of the display 132. Then, the device input reception module 2033 receives the information of the type of block pattern or device and the allocation position in the virtual space that are input.

The predetermined operation on the screen of the display 132 that is received by the device input reception module 2033 may be, for example, an operation of selecting via clicking a desired type from a plurality of block patterns with different patterns or a list of various devices displayed on the screen and selecting the allocation position via clicking a desired section of the virtual space displayed on the screen. Furthermore, another example of the predetermined operation is an operation of selecting an allocation position by selecting and dragging a desired image from a list of images indicating the appearance of a block pattern or device displayed on the screen, and moving the selected image to a desired section of the virtual space displayed on the screen. Note that the input of the block pattern or device is not limited to such input operations.

The device allocation module 2034 controls the processing for allocating objects in the virtual space and displaying the objects on the basis of the information of the type of the block pattern or device and the allocation position in the virtual space that are received by the device input reception module 2033. The information of the type of the block pattern or device to be allocated in the virtual space and the allocation position in the virtual space is received via a predetermined operation on the terminal apparatus 10 by the user. Thus, on the basis of this information, the block pattern or device is allocated at the input allocation position in the virtual space displayed on the display 132 of the terminal apparatus 10 and displayed on the display 132 of the terminal apparatus 10.

The device editing input reception module 2035 controls the processing for receiving, from a user, an input operation (object edit operation) for editing the block pattern or device received by the device input reception module 2033. The user inputs edit information for performing various adjustments to the block pattern or device displayed on the display 132 of the terminal apparatus 10. Thus, the device editing input reception module 2035 receives the input edit information of the block pattern or device. Editing of the block patterns or various devices includes editing one or more of usability, operability, ease-of-construction, and accessibility of the device, for example.

An input operation for editing the block pattern or device made by a user at the device editing input reception module 2035 is, for example, an input operation for editing the parameters set for the block pattern or device. Another example of an input operation by a user is an input operation for editing, via dragging or the like, the size, length, and the like of the block pattern or device displayed on the display 132, with values corresponding to the size and length being received as parameters. Examples of the editable parameters of the block pattern include the length of the installed pipe and the angle of connection with the device, and details of the parameters will be described later.

The device editing display module 2036 controls the processing for changing how the block pattern and device are displayed and displaying these in the virtual space on the basis of the edit information of the block pattern or device received by the device editing input reception module 2035. The information relating to editing the block pattern or device allocated in the virtual space and editing the length of the installed pipe and the angle of connection with the device are received via a predetermined operation on the terminal apparatus 10 by the user. Thus, on the basis of this information, how the block pattern or device is displayed in the virtual space displayed on the display 132 of the terminal apparatus 10 is changed, for example, the appearance is changed to match the received length of the installed pipe and the angle of connection with the device, and these are displayed on the display 132 of the terminal apparatus 10.

The pipe routing module 2037 controls the processing for receiving, from a user, an instruction operation (routing operation) for associating the routing of the pipes disposed in the plant being designed using the plant design system 1 with the block pattern or device allocated in the virtual space, and for performing pipe routing. “Pipes disposed in the plant” refers to pipes through which fluids, such as liquids and gases, flow and includes, for example, pipes for transporting the source gas in the plant, pipes for transporting absorption liquid for absorbing the component removed from the source gas, pipes for transporting the exhaust gas, and the like. The user, using the screen displayed on the display 132 of the terminal apparatus 10, designates a predetermined point of the block pattern or device allocated in the virtual space, for example, an end point of the installed pipe of the block pattern, as the starting location or the ending location of the routing and performs an instruction operation (for example, presses a predetermined button on the screen) for pipe routing. This instruction is received by the pipe routing module 2037, and pipe routing is performed. Note that the instruction operation by the user is not limited to pressing a predetermined button on the screen, and in another configuration, the pipe routing may be automatically performed when the block pattern is allocated, for example.

Note that the pipe routing module 2037 may perform pipe routing on the basis of detailed information input by a user in the virtual space (manual routing) or may perform automatic routing when the user designates the starting and ending points. In this case, the direction of the pipe routing is determined according to a predetermined condition, and automatic routing is performed via an algorithm that avoids existing block patterns or devices and pipes. Alternatively, the pipe routing module 2037 may be configured to perform routing according to pipe diameters or materials designated by parameters input by the user or parameters set in advance, or may be configured to recommend piping optimized in terms of pipe diameter and materials for the flow of a fluid.

In the present embodiment, as described above, the server 20 is configured to receive input of the type of block pattern or device and the allocation position and send a display instruction to the terminal apparatus 10, receive an edit input for the block pattern or device and send a display instruction to the terminal apparatus 10, and receive a pipe routing instruction and perform routing to be displayed on the terminal apparatus 10. However, the configuration is not limited thereto. For example, some or all of the functions described above may be configured such that an input is received by the terminal apparatus 10, processing is executed in the terminal apparatus 10, and the display is displayed on the display 132 of the terminal apparatus 10. With such a configuration, the user may access the server 20 via the terminal apparatus 10, install a program provided by the server 20 on the terminal apparatus 10, and execute processing in the terminal apparatus 10. In this case, as a function of the server 20, some or all of the device input reception module 2033, the device allocation module 2034, the device editing input reception module 2035, the device editing display module 2036, or the pipe routing module 2037 may not be provided.

2. Block Pattern

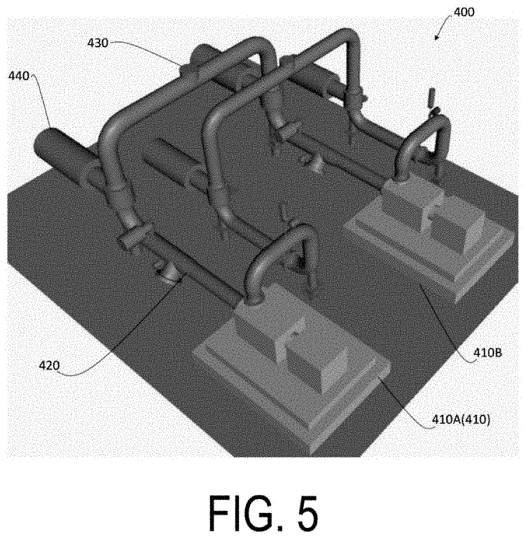

A block pattern and editing thereof will be described below with reference to FIGS. 5 to 8. As described above, the device constituting the block pattern specifically includes a pump, a heat exchanger, a filter, and a valve. For each type of device, the detailed configuration of the block pattern and the editable parameters will be described.

The block patterns illustrated in FIGS. 5 to 8 are model data used in a 3D CAD system using 3D computer graphics (3DCG) technology. In a 3D CAD system, modeling is performed by building a three-dimensional virtual space and representing the shape of individual objects in the three-dimensional virtual space. In addition, the viewpoint (virtual camera) in the virtual space is set, and the individual objects (in the present embodiment, a block pattern, a device, and routed pipes) are rendered according to the virtual camera settings. The block pattern described below is a block pattern actually rendered using a predetermined virtual camera viewpoint.

FIG. 5 is an appearance view illustrating a pump as an example of a block pattern that can be edited via the plant design system 1 of the first embodiment. Note that the appearance of the pump is the same as the block pattern 100 illustrated in FIG. 1.

A block pattern 400 illustrated in FIG. 5 is a schematic of a pump that is a device disposed inside the plant for suctioning and transporting a fluid utilizing pressure, and includes one or a plurality of pumps 410A and 410B, an installed pipe 420, a connection portion (header) 430, and a valve 440. Such a pump is, for example, equipment to be used for transporting source gas, absorption liquid, and exhaust gas within pipes inside the plant. Note that there are various types of pumps including an end-top type with an intake provided on the rotary shaft side (end) of the pump casing and an outlet provided on an upper side (top) of the pump casing, a top-top type with an intake and an outlet provided on an upper side (top) of the pump casing, and a side-side type with an intake and an outlet provided on a lateral side (side) of the pump casing, and the appropriate pump is used depending on connection conditions with other devices or the like when placement in the plant is performed.

In a case where the device type of the block pattern 400 is a pump, a plurality of patterns are provided according to the functional requirements indicated in the P&ID including, for example, the type of pumps 410A, 410B, the arrangement of the valve 440, the outlet size, the type of flow meter installed in the installed pipe 420, and the number of valves 440. In addition, the block pattern 400 is configured as image information with different appearances for each of the functional requirements. In this example, the type of the pumps 410A, 410B is allocation information of the intake and the outlet and includes the end-top type, the top-top type, and the side-side type described above, for example. The arrangement of the valve 440 is information of the direction in which the valve is disposed on the installed pipe 420 and includes vertical and horizontal, with the valve 440 illustrated in FIG. 5 being horizontal. The user selects the desired type from such a plurality of block patterns as a block pattern to be input to the device input reception module 2033.

In addition, in a case where the device type of the block pattern 400 is a pump, by editing the parameters, for example, the number of devices including the pumps 410A and 410B (two in the case of the block pattern 400 illustrated in FIG. 5), the access space, i.e., the distance between the pump 410A and the pump 410B, the length of the installed pipe 420, the angle of connection between the pumps 410A, 410B and the installed pipe 420, the number of the valves 440, the type of the connection portion 430, and the height of the bottom of pipe (BOP) of the piping can be edited. The user inputs a desired value for an edit item as an edit parameter to be input to the device editing input reception module 2035.

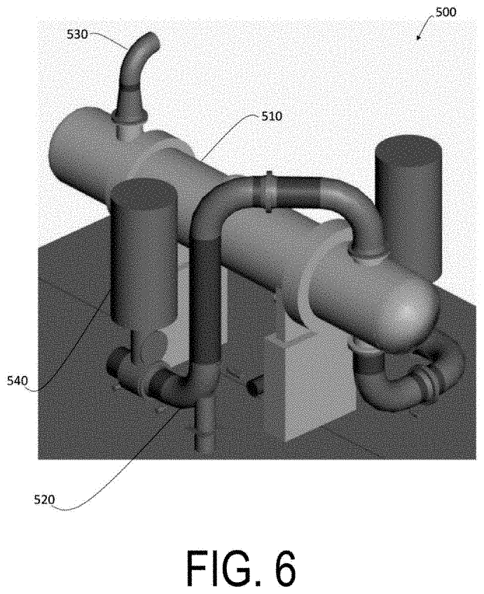

FIG. 6 is an appearance view illustrating a heat exchanger as an example of a block pattern that can be edited via the plant design system 1 of the first embodiment.

A block pattern 500 illustrated in FIG. 6 is a schematic of a heat exchanger that is a device disposed inside the plant and that performs heating and cooling by efficiently moving heat from a high temperature object (medium) to a low temperature object (medium), and includes a heat exchanger 510, an installed pipe 520, a connection portion 530, and a valve 540. Such a heat exchanger is, for example, equipment to be used for vaporizing LNG and cooling or liquefying a source gas inside the plant, for example. Note that there are various types of heat exchangers including, for example, a shield and tube heat exchanger with a plurality of small cylindrical tubes disposed in a cylindrical body, an air-cooled heat exchanger that uses air as a refrigerant, and a plate heat exchanger that performs heat exchange via a thin plate-like heat transfer portion with a complex press shape, and the appropriate heat exchanger is used depending on the heat exchange functional requirements.

In a case where the device type of the block pattern 500 is a heat exchanger, a plurality of patterns are provided according to the functional requirements indicated in the P&ID including, for example, the type of the heat exchanger 510, the number of devices including the heat exchanger 510 (one in the case of the block pattern 500 illustrated in FIG. 6), and the allocation position of the heat exchanger 510. In addition, the block pattern 500 is configured as image information with different appearances for each of the functional requirements. In this example, the type of the heat exchanger 510 is information of the type of heat exchanger, such as the shield and tube heat exchanger, the air-cooled heat exchanger, and the plate heat exchanger described above. The user selects the desired type from such a plurality of block patterns as a block pattern to be input to the device input reception module 2033.

In addition, in the case where the device type of the block pattern 500 is a heat exchanger, by editing the parameters, for example, the orientation and angle of the connection portion 530, the length of the installed pipe 520, the number of the valves 540, the number of nozzles, and the height of the bottom of pipe (BOP) of the piping can be edited. The user inputs a desired value for an edit item as an edit parameter to be input to the device editing input reception module 2035.

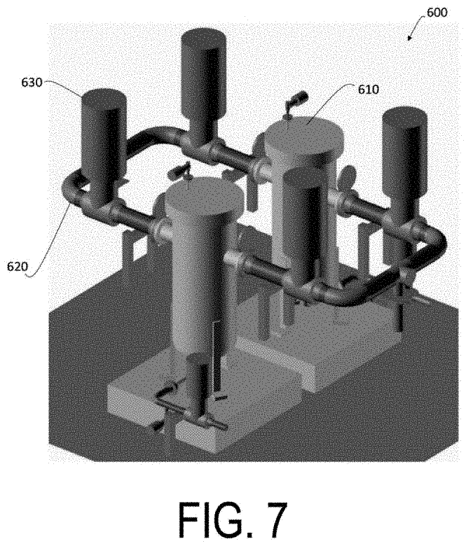

FIG. 7 is an appearance view illustrating a filter as an example of a block pattern that can be edited via the plant design system 1 of the first embodiment.

A block pattern 600 illustrated in FIG. 7 is a schematic of a filter that is a device disposed inside the plant for removing impurities and the like in the fluid, and includes a filter equipment 610, an installed pipe 620, and a valve 630. Such a filter is, for example, equipment to be used for removing impurities contained in the source gas inside the plant.

In a case where the device type of the block pattern 600 is a filter, a plurality of patterns are provided according to the functional requirements indicated in the P&ID including, for example, the number and allocation position of the valves 630. In addition, the block pattern 600 is configured as image information with different appearances for each of the functional requirements. The user selects the desired type from such a plurality of block patterns as a block pattern to be input to the device input reception module 2033.

In addition, in a case where the device type of the block pattern 600 is a filter, the nozzle height and the height of the bottom of pipe BOP can be edited. The user inputs a desired value for an edit item as an edit parameter to be input to the device editing input reception module 2035.

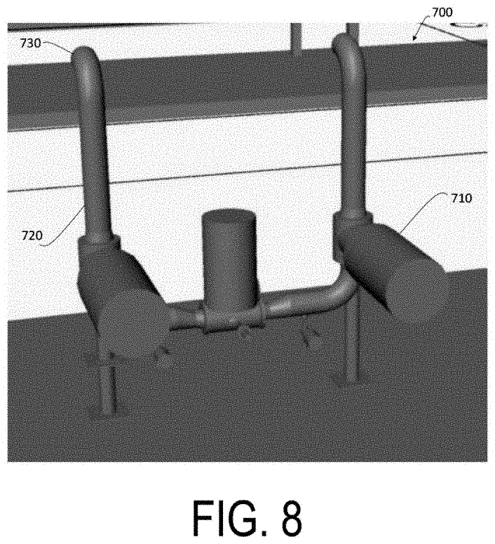

FIG. 8 is an appearance view illustrating a valve set as an example of a block pattern that can be edited via the plant design system 1 of the first embodiment.

A block pattern 700 illustrated in FIG. 8 is a schematic of a valve set that is a set of a plurality of valves that are devices disposed inside the plant for controlling the flow of the fluid in the pipes, and includes a valve 710, an installed pipe 720, and a connection portion 730. Such a valve is, for example, equipment to be used for controlling the on/off of the transport of source gas or exhaust gas inside the plant and for controlling the flow rate.

In a case where the device type of the block pattern 700 is a valve set, a plurality of patterns are provided according to the functional requirements indicated in the P&ID including, for example, the arrangement of the valve 710 and the layout of the installed pipe 720. In addition, the block pattern 700 is configured as image information with different appearances for each of the functional requirements. The user selects the desired type from such a plurality of block patterns as a block pattern to be input to the device input reception module 2033.

In addition, in a case where the device type of the block pattern 700 is a valve set, the length of the installed pipe 720 and the angle of connection between the valve 710 and the installed pipe 720 can be edited. The user inputs a desired value for an edit item as an edit parameter to be input to the device editing input reception module 2035.

Note that, in addition to the block pattern, for each of the types of devices, a plurality of patterns may be provided according to the device type and the functional requirement, and the parameters thereof may be editable. In addition, the type of block pattern illustrated in FIGS. 5 to 8, the plurality of patterns according to the functional requirements of the block patterns, and the editable parameters are merely examples, and no limitations are intended on the type of the block patterns, the sorting of the patterns, and the setting of parameters.

3. Data Structure

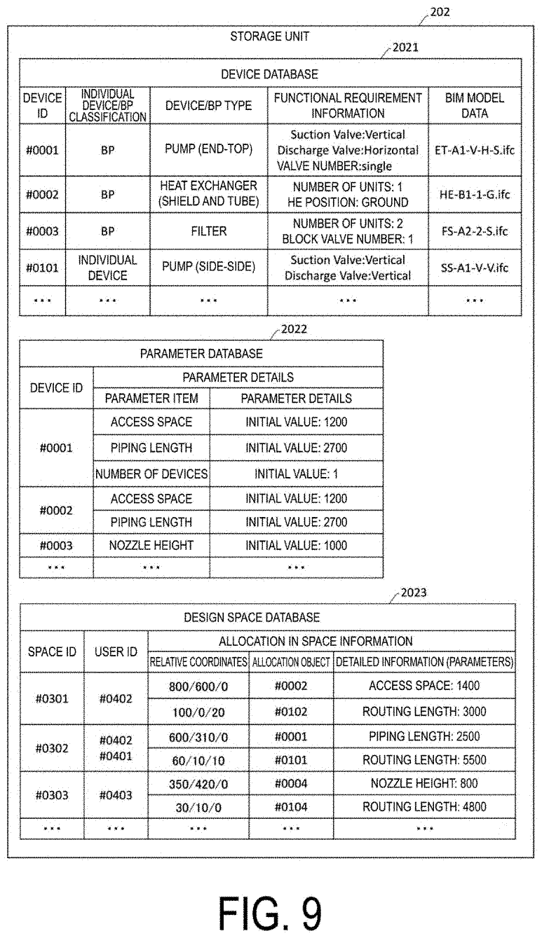

FIG. 9 is a diagram showing the data structure of the device database 2021, the parameter database 2022, and the design space database 2023 stored by the server 20.

As shown in FIG. 9, the records in the device database 2021 include the item “Device ID”, the item “Individual Device/BP Classification”, the item “Device/BP type”, the item “Functional Requirement Information”, and the item “BIM model data”.

The item “Device ID” is information for identifying the type of the individual device or block pattern that can be allocated in the virtual space in the plant design system 1.

The item “Individual Device/BP Classification” is information for identifying whether the record is for an individual device or a block pattern.

The item “Device/BP Type” is the name indicating the type of the individual device or block pattern, and here information of names indicating types such as pumps, heat exchangers, filters, and valves are stored. In addition, in the case of a pump or heat exchanger, information indicating the type of pump, for example, an end-top type, and the type of heat exchanger, for example, a shield and tube heat exchanger, is stored. Note that a name indicating the type of an individual device or a block pattern may be a symbol specified by a predetermined standard or the like, or a model number or the like specified by the manufacturer.

The item “Functional Requirement Information” stores information of the functional requirement indicated by the P&ID regarding the individual device or block pattern. The information of the functional requirement is information such as the type of pump in the case of a pump, the arrangement of the valves, the outlet size, the type of flow meter, and the number of valves. Note that information of the positions configurable as the starting and ending points for pipe routing may also be stored, but this is not shown in the diagram.

The item “BIM model data” is information indicating a data name (file name) of model data to be allocated in the virtual space by the plant design system 1, and is model data to be used in a 3D CAD system. In a 3D CAD system provided by the server 20, modeling is performed by building a three-dimensional virtual space and representing the shape of an individual device or a block pattern in the three-dimensional virtual space. In addition, the viewpoint (virtual camera) in the virtual space is set, and the individual device or the block pattern are rendered according to the virtual camera settings. The model data stored in the item “BIM model data” is model data for rendering an actual individual device or block pattern using a predetermined virtual camera viewpoint.

The records in the parameter database 2022 include the item “Device ID”, the item “Parameter”, and the like.

The item “Device ID” is information for identifying the type of the individual device or block pattern that can be allocated in the virtual space in the plant design system 1 and corresponds to the item “Device ID” of the device database 2021.

The item “Parameter” is information relating to an editable parameter for an individual device or block pattern in the plant design system 1, and specifically includes the item “Parameter Item”, the item “Parameter Details”, and the like.

The item “Parameter item” is the name indicating the item name of an editable parameter for the individual device or block pattern and is, for example, item information, such as access space between devices in the case of a pump, the length of the installed pipe, the angle of connection between the pump and the installed pipe, the number of valves, the header type, and the height of the bottom of pipe BOP.

The item “Parameter Details” is detailed information of an editable parameter for the individual device or block pattern and includes, for example, the initial value for each parameter (a value in a state before user configuration).

The records in the design space database 2023 include the item “Space ID”, the item “User ID”, the item “Piping in Space Information”, and the like.

The item “Space ID” is information for identifying the information of the virtual space designed by the user in the plant design system 1.

The item “User ID” is information for identifying the users of the plant design system 1. Note that, in the item “User ID”, information for identifying a plurality of users may be stored, as shown in the example with “#0302” in the item “Space ID”. This is to allow one virtual space to be designed and shared by a plurality of users, and information of the item “Piping in Space Information” described below may be stored in association with each user.

The item “Piping in Space Information” is information relating to a block pattern or an individual device allocated in a virtual space by a user and routed pipes in the plant design system 1 and specifically includes the item “Relative Coordinates”, the item “Allocation Object”, the item “Detailed Information (Parameter)”, and the like.

The item “Relative Coordinates” is information indicating the relative position in the virtual space of the block pattern, the individual device, and the pipes allocated in the virtual space, and stores coordinate data of three-dimensional coordinates in the virtual space, for example. The relative coordinates are, for example, relative coordinates, with the virtual space represented by XYZ coordinates, of positions acting as a reference for a block pattern, an individual device, and pipes (for example, a center position or an end point in one of the six directions). However, the system is not limited thereto.

The item “Placement Object” is information indicating a block pattern, an individual device, or pipes allocated in the virtual space and corresponds to the item “Device ID” of the device database 2021.

The item “Detailed Information (Parameter)” is edit information of edits to a block pattern, an individual device, or pipes allocated in the virtual space and is information of routed pipes. For example, the edited parameters of the block pattern or the individual device is stored.

The device input reception module 2033 of the server 20 adds and updates records in the design space database 2023 when allocation information of a block pattern or an individual device is received from a user. The device editing input reception module 2035 adds and updates records in the design space database 2023 when parameter information of a block pattern or an individual device is received from a user. The pipe routing module 2037 adds and updates records in the design space database 2023 when pipe routing processing is executed.

4. Operation

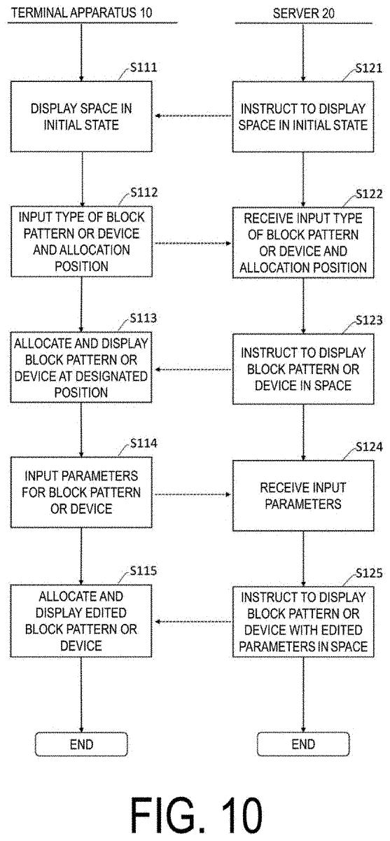

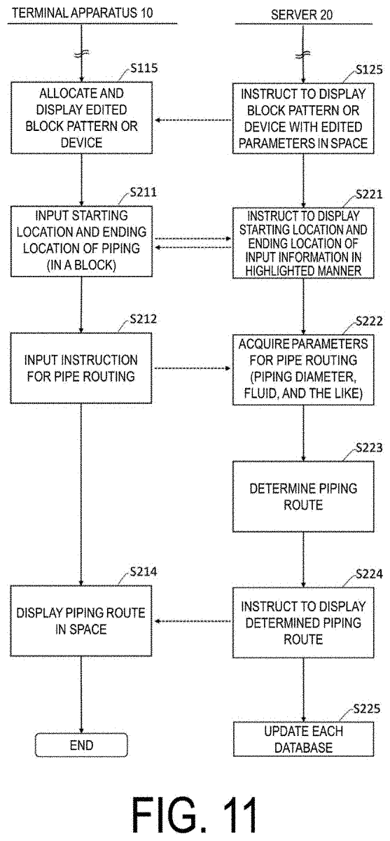

The edit processing of a block pattern or a device and the piping route determination processing performed by the plant design system 1 according to the first embodiment will be described below with reference to FIGS. 10 and 11.

FIG. 10 is a flowchart illustrating an example of the flow of edit processing of a block pattern or a device by the plant design system 1 of the first embodiment. For example, the user accesses the server 20 via a web browser of the terminal apparatus 10 and instructs the server 20 to provide a plant design service provided by the server 20 to start the processing. At this time, a predetermined authentication of the user may be performed.

In step S121, the control unit 203 of the server 20 receives an input of the type of a block pattern or device to be allocated in a virtual space where plant design is to be performed and the allocation position in the virtual space. Then, the control unit 203 transmits, to the terminal apparatus 10 via the communication unit 201, an instruction to display the space in an initial state.

In step S111, the transceiver unit 172 of the terminal apparatus 10 receives instruction information to display the space in an initial state transmitted from the server 20. The notification control unit 174 displays the space in an initial state on the display 132. The information on the space in an initial state may be transmitted to the terminal apparatus 10 by the control unit 203 of the server 20 or may be stored in advance by the terminal apparatus 10.

In step S112, the input operation reception unit 171 of the terminal apparatus 10 receives, from the user, an input operation (object allocation operation) of the type of block pattern or device and the allocation position in the virtual space. The transceiver unit 172 transmits to the server 20 the information of the type of the block pattern or device, the allocation position in the virtual space, and user information that are received.

In step S122, the device input reception module 2033 of the server 20 receives, via the communication unit 201, the information of the type of the block pattern or device and the allocation position in the virtual space, and the user information, transmitted from the terminal apparatus 10.

In step S123, the device allocation module 2034 of the server 20 references the device database 2021 on the basis of the information of the type of the block pattern or device and the allocation position in the virtual space that are received in step S122 and transmits instruction information for allocating and displaying, in the virtual space, a block pattern illustrated as in FIGS. 5 to 8 or various devices to the terminal apparatus 10 via the communication unit 201. In addition, the device allocation module 2034 stores, in the design space database 2023, the information of the type of the block pattern or device and the allocation position in the virtual space that are received.

In step S113, the transceiver unit 172 receives the instruction information to allocate and display the block pattern or device transmitted from the server 20 in the virtual space. The notification control unit 174 allocates the block pattern or device in the virtual space and displays them on the display 132.

In step S114, the input operation reception unit 171 of the terminal apparatus 10 receives, from the user, an input operation (object edit operation) to edit the block pattern or device. The transceiver unit 172 transmits the received edit information (parameters) of the block pattern or device and user information to the server 20.

In step S124, the device editing input reception module 2035 of the server 20 receives, via the communication unit 201, the edit information of the block pattern or device and the user information transmitted from the terminal apparatus 10.

In step S125, the device editing display module 2036 of the server 20 references the parameter database 2022 on the basis of the edit information of the block pattern or device received in step S124 and transmits instruction information for changing how the block pattern or device as in FIGS. 5 to 8 is displayed and displaying this in the virtual space to the terminal apparatus 10 via the communication unit 201. In addition, the device editing display module 2036 stores, in the design space database 2023, the received edit information of the block pattern or device.

In step S115, the transceiver unit 172 receives the instruction information to change how the block pattern or device is displayed transmitted from the server 20 and display this in the virtual space. The notification control unit 174 changes how the block pattern or device is displayed, allocates them in the virtual space, and displays them on the display 132.

In the example of the flowchart illustrated in FIG. 10, as described above, at the server 20, an input of the type of a block pattern or device and the allocation position is received, a display instruction is sent to the terminal apparatus 10, an edit input of the block pattern or device is received, and this is displayed on the terminal apparatus 10. However, the processing process is not limited thereto. For example, in another configuration, some or all of the processing executed by the server 20 described above may be executed in the terminal apparatus 10 after receiving input at the terminal apparatus 10. In this case, some or all of the processing of steps S122 to S125 may be executed at the terminal apparatus 10.

As described above, the user of the plant design system 1 inputs the type of the block pattern or device to be allocated in the virtual space where plant design is to be performed and the allocation position in the virtual space. The block pattern or device is allocated in the virtual space where plant design is to be performed on the basis of the input information. In addition, the user inputs edit information of the block pattern or device. How the block pattern or device is displayed is changed and these are displayed in the virtual space on the basis of the input information. In this manner, when designing a large-scale facility such as a chemical plant, the user can allocate an object provided with pipes or devices in advance for one or a plurality of devices.

FIG. 11 is a flowchart illustrating an example of the flow of piping route determination processing performed by the plant design system 1 of the first embodiment. The piping route determination processing of the flowchart illustrated in FIG. 11 includes the additional processing of steps S211 and S221 and onwards executed following on from the steps S115 and S125 of the operation mode switch processing in the flowchart illustrated in FIG. 10, respectively, and thus redundant description of this processing will not be repeated. Note that in the flowchart illustrated in FIG. 11, the steps S111 to S114 and steps S121 to S124 are not illustrated.

In step S211, the input operation reception unit 171 of the terminal apparatus 10 receives from a user an input for designating, as the starting and ending points of pipe routing, a predetermined point of a block pattern or device allocated in the virtual space (for example, an end point of an installed pipe of a block pattern) displayed on the display 132. Note that the starting and ending points of the routing that can be designated by the user may be displayed in a manner such that the connection portion 430 of the block pattern 400 illustrated in FIG. 5 can be designated. The transceiver unit 172 transmits the input information of the received starting and ending points of the pipe routing to the server 20. Thereafter, the transceiver unit 172 receives the instruction information for causing the starting and ending points of the pipe routing transmitted from the server 20 to be displayed in a highlighted manner. The notification control unit 174 causes the display 132 to display, in a highlighted manner, the starting and ending points of the pipe routing designated by the user.

In step S221, the pipe routing module 2037 of the server 20 receives, via the communication unit 201, the input information of the starting and ending points of the pipe routing transmitted from the terminal apparatus 10. The pipe routing module 2037 transmits, to the terminal apparatus 10 via the communication unit 201, instruction information for displaying the designated starting and ending points of the pipe routing in a highlighted manner, on the basis of the received information of the starting and ending points of the pipe routing.

In step S212, the input operation reception unit 171 of the terminal apparatus 10 receives, from the user, input of an instruction to perform pipe routing in the virtual space displayed on the display 132 and input information of the parameters (pipe diameter, material, and the like) for pipe routing. The transceiver unit 172 transmits the received instruction information of the pipe routing to the server 20.

In step S222, the pipe routing module 2037 of the server 20 receives, via the communication unit 201, the instruction information for performing pipe routing and the input information of the parameters for pipe routing received from the terminal apparatus 10. Note that the pipe routing module 2037 may acquire the parameter information for pipe routing from preset information stored in the storage unit 202.

In step S223, the pipe routing module 2037 of the server 20 determines the piping routes on the basis of the starting and ending points of the pipe routing received in step S221 and the parameter information for pipe routing acquired in step S222. At this time, automatic routing may be performed via a predetermined algorithm.

In step S224, the pipe routing module 2037 of the server 20 transmits the determined piping route information and the instruction information for displaying the piping route to the terminal apparatus 10 via the communication unit 201.

In step S214, the transceiver unit 172 receives the piping route information and the instruction information for displaying the piping route transmitted from the server 20. The notification control unit 174 causes the display 132 to display the pipes in a routed state.

In step S225, the pipe routing module 2037 of the server 20 stores the determined piping route information in the design space database 2023.

Note that in the example of the flowchart illustrated in FIG. 11, as described above, at the server 20, an instruction for pipe routing is received, the piping route is determined, and a display instruction is sent to the terminal apparatus 10. However, the processing process is not limited thereto. For example, in another configuration, the processing executed by the server 20 described above may be executed in the terminal apparatus 10 after receiving input at the terminal apparatus 10. In this case, some or all of the processing of steps S221 to S224 may be executed at the terminal apparatus 10.

As described above, the user of the plant design system 1 performs input designating the starting and ending points of the pipe routing to designate the pipe routing. The piping route from the starting point to the ending point of the piping is determined on the basis of the parameters for pipe routing input by the user or set in advance and is then displayed on the display 132 of the terminal apparatus 10. This allows the user to design the piping route based on user-set conditions, and allows the user to design appropriate piping route by changing the conditions.

5. Screen Example

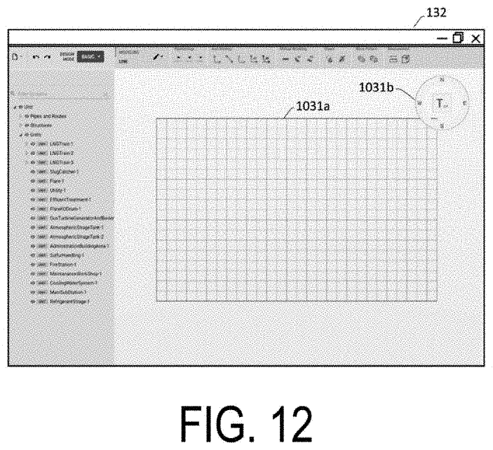

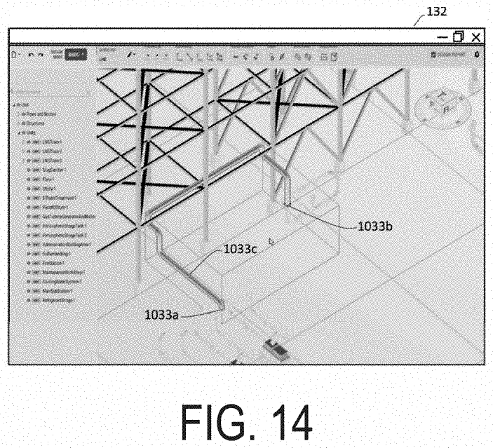

Examples of screens for the edit processing of a block pattern or a device and the piping route determination processing by the plant design system 1 will be described below with reference to FIGS. 12 and 14.

FIG. 12 is a diagram illustrating an example of a screen of the terminal apparatus 10 displaying space in the initial state. The screen example of FIG. 12 is an example of a screen on the terminal apparatus 10 of the user displaying a virtual space in an initial state for receiving input of the type of the block pattern or device and the allocation position. This corresponds to step S111 in FIG. 10.

As illustrated in FIG. 12, on the display 132 of the terminal apparatus 10, a virtual space 1031a in an initial state is displayed as a grid-like input screen. One or a plurality of block patterns or devices can be input to discretionary locations in the grid-like virtual space 1031a.

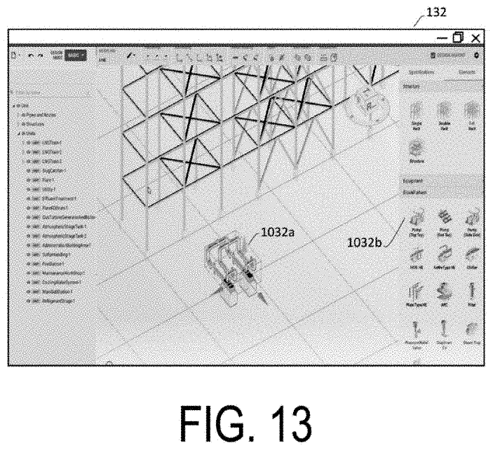

When a discretionary location in the virtual space 1031a illustrated in FIG. 12 is selected via clicking or the like and the location is moved via dragging, the display range or orientation of the virtual space 1031a can be moved. For example, the display range moves in accordance with the movement in the up-down and left-right directions, and the display range rotates when rotation movement is made. In this example, the virtual space 1031a illustrated in FIG. 12 is planar, but the virtual space 1031a can be displayed in three-dimensions as illustrated in FIG. 13 and the like by rotating. In addition, a diagonal display section 1031b is provided so that the direction (north, south, east, and west) of the display direction can be known when the display range is rotated, with the diagonal display section 1031b moving in accordance with the rotation of the virtual space 1031a.

FIG. 13 is a diagram illustrating an example of a screen of the terminal apparatus 10 for block pattern editing. The screen example in FIG. 13 is an example of a screen with a block pattern allocated in the virtual space 1031a illustrated in FIG. 12 via a user operation. This corresponds to step S112 in FIG. 10.

As illustrated in FIG. 13, on the display 132 of the terminal apparatus 10, a block pattern 1032a is displayed allocated in a grid-like virtual space similar to the virtual space 1031a illustrated in FIG. 12. Furthermore, on the right side of the display 132, a block pattern selection section 1032b where types of block patterns stored in the device database 2021 can be selected is provided. The block pattern 1032a is a block pattern stored in the device database 2021 and illustrated as a pump in this example.

The user performs an operation of selecting (for example, clicking on the screen) a discretionary location in the virtual space as a location for allocating the object. Then, with the block pattern selection section 1032b displayed, the type of block pattern is selected (for example, by clicking on the screen) from the displayed contents to display the selected block pattern 1032a as illustrated in FIG. 13. In addition, when the block pattern 1032a is selected, an input field for the editable parameters is displayed on the right side, and the block pattern 1032a can be edited (for example, changing the number of devices or the allocation of the devices) via input to this field. Note that a fluid intake and outlet (also called a suction pipe and a discharge pipe) are provided on the installed pipe of the block pattern 1032a, and the intake and the outlet may be displayed in different manners (for example, having a different color or different image).

FIG. 14 is a diagram illustrating an example of a screen of the terminal apparatus 10 displaying a piping route. The screen example of FIG. 14 is an example of a screen on which a piping route running from a selected starting location to a selected ending location is determined and displayed in the space displayed on the terminal apparatus 10 of the user via a user operation. This corresponds to step S214 in FIG. 11.

As illustrated in FIG. 14, a piping route 1033c obtained via routing is displayed on the display 132 of the terminal apparatus 10, with the piping route 1033c running from an end point 1033a of an installed pipe of a block pattern similar to the block pattern 1032a illustrated in FIG. 13 to an end point 1033b of an installed pipe of another block pattern.

The user selects the end point 1033a illustrated in FIG. 14 as the starting location (connection location) and selects the end point 1033b as the ending location (connection location) (the starting location and the ending location may be reversed). When a pipe routing operation is performed in this state, the piping route 1033c is determined and displayed. In this case, the direction of the pipe routing is determined according to a predetermined condition, automatic routing is performed via an algorithm that avoids existing facilities, devices, and pipes, and the piping route 1033c is determined. Note that when the user selects the end point 1033a as the starting location and the end point 1033b as the ending location, the end point 1033a and the end point 1033b may be displayed in different manners (for example, having a different color or different image).

### SUMMARY

As described above, according to the present embodiment, a plurality of patterns for a block pattern (first object), which is an object in which pipes are allocated in advance for a device constituting the plant, are set according to the functional requirements of the plant. A user performing plant design can select a block pattern and allocate this pattern in a virtual space where plant design is performed. This allows the user to easily determine routing near connection points to devices that constitute the plant when designing a chemical plant, for example.

In addition, parameters for editing a device or pipe are set for the block pattern such that and various edits can be made by the user. By the parameters being edited by a user performing plant design, for example, edits can be made according to one or more of usability, operability, ease-of-construction, and accessibility of the device in the block pattern. This allows the user to optimally place a device that constitutes the plant when designing a chemical plant, for example.

Furthermore, the pipe routing from the starting point to the ending point of the piping is determined on the basis of the parameters for pipe routing according to a user instruction or set in advance. This makes it possible to easily perform the design of the piping route required for facilities such as chemical plants.

Embodiments according to the disclosure have been described above, but these embodiments can be implemented in various other forms, and various omissions, substitutions, and changes can be made. These embodiments and modified examples, as well as omissions, substitutions and changes, are included in the technical scope of the claims and the equivalent scope thereof.

Note

The contents of the embodiments described above are noted below.

Note 1

A computer program for causing a processor (29) to execute processing relating to three-dimensional space design of a plant, wherein

the computer program causes the processor (29) to execute:

receiving (S122) from a user an object allocation operation (S112) for designating a position in a virtual space to allocate a first object (100), which is an object in which a pipe is preset for a device constituting the plant;

allocating (S123) the first object in the virtual space in response to the object allocation operation;

receiving a routing operation from a user; and

performing (S222 to S224) pipe routing for connection to an end of the pipe of the allocated first object in response to the routing operation.

Note 2

The computer program according to Note 1, wherein in the receiving (S122) from a user the object allocation operation, an operation for designating a type of the first object or a second object, which is a device constituting the plant, and a position in the virtual space to allocate the first object or the second object is received; and

in the allocating (S123) in response to the object allocation operation, the first object or the second object is allocated at the designated position.

Note 3

The computer program according to Note 2, wherein the computer program causes the processor to further execute:

receiving (S124) from a user an object edit operation for editing the first object or the second object allocated in the virtual space, and

allocating (S125) the edited first object or the edited second object in the virtual space.

Note 4

The computer program according to Note 3, wherein in the receiving (S124) from a user the object edit operation, the editing includes receiving an input of a parameter set for the first object or the second object; and in the allocating (S125) the edited first object or the edited second object, in response to an input of the parameter, the first object or the second object corresponding to the parameter is allocated in the virtual space.

Note 5

The computer program according to Note 4, wherein in the allocating (S125) the edited first object or the edited second object, the edited first object or the edited second object is allocated in the virtual space based on the parameter and information of a preset functional requirement.

Note 6

The computer program according to any one of Notes 3 to 5, wherein in the receiving (S124) from a user the object edit operation, the editing includes receiving an input operation to edit according to one or more of usability, operability, ease-of-construction, and accessibility of the device in the plant.

Note 7

The computer program according to any one of Notes 3 to 6, wherein in the receiving (S124) from a user the object edit operation, the editing includes receiving an input operation to edit a length and an installed angle of a pipe preset for the first object.

Note 8

The computer program according to Note 7, wherein the pipe preset for the first object includes an intake for fluid supplied to the pipe and/or an outlet for the fluid.

Note 9

The computer program according to Note 8, wherein in the receiving (S124) from a user the object edit operation, the editing includes receiving an input operation for changing the intake or the outlet for the fluid in the pipe.

Note 10

The computer program according to any one of Notes 3 to 9, wherein the first object includes one or a plurality of the devices.

Note 11

The computer program according to Note 10, wherein a pipe is preset for each of the one or the plurality of the devices of the first object.

Note 12

The computer program according to note 10 or 11, wherein in the receiving (S124) from a user the object edit operation, the editing includes receiving an input operation for editing the number of the devices.

Note 13

The computer program according to Note 12, wherein in a case where the number of the devices is more than one, a plurality of intakes or outlets allocated on each of the devices are integrated.

Note 14

The computer program according to any one of Notes 3 to 13, wherein

the device includes one or a plurality of a pump, a heat exchanger, a filter, a valve, a piping member, and an instrument.

Note 15

The computer program according to Note 14, wherein one or a plurality of the valves are allocated on the pipe preset for the first object.

Note 16

The computer program according to Note 14, wherein in the receiving (S124) from a user the object edit operation, in a case where the device is a pump, the editing includes receiving an edit input for editing a type of the pump.

Note 17

The computer program according to Note 14, wherein in the receiving (S124) from a user the object edit operation, in a case where the device is a heat exchanger, the editing includes receiving an edit input for editing a type of the heat exchanger and/or a type of a layout for the heat exchanger.

Note 18

The computer program according to Note 14, wherein in the receiving (S124) from a user the object edit operation, in a case where the device is a filter, the editing includes receiving an edit input for editing a type of the filter.

Note 19

The computer program according to Note 14, wherein in the receiving (S124) from a user the object edit operation, in a case where the device is a valve, the editing includes receiving an edit input for editing a type of the valve and/or a type of an arrangement of the valve.

Note 20

A three-dimensional space design apparatus provided with a control unit for causing the control unit to execute processing relating to three-dimensional space design of a plant, wherein the control unit executes:

receiving from a user an object allocation operation for designating a position in a virtual space to allocate a first object, which is an object in which a pipe is preset for a device constituting the plant;

allocating the first object in the virtual space in response to the object allocation operation;

receiving a routing operation from a user; and performing pipe routing for connection to an end of the pipe of the allocated first object in response to the routing operation.

Note 21

A method for executing processing relating to three-dimensional space design of a plant that is executed by a computer provided with a processor, the method comprising:

by the processor,

receiving from a user an object allocation operation for designating a position in a virtual space to allocate a first object, which is an object in which a pipe is preset for a device constituting the plant;

allocating the first object in the virtual space in response to the object allocation operation;

receiving a routing operation from a user; and performing pipe routing for connection to an end of the pipe of the allocated first object in response to the routing operation.

1. A three-dimensional space design apparatus provided with a processing circuitry configured to execute processing relating to three-dimensional space design of a plant, wherein
the processing circuitry executes:
receiving from a user an object allocation operation for designating a position in a virtual space to allocate a first object, which is an object in which a pipe is preset for a device constituting the plant;
allocating the first object in the virtual space in response to the object allocation operation from a user;
receiving a routing operation from a user; and
performing pipe routing for connection to an end of the pipe of the allocated first object in response to the routing operation.

2. The three-dimensional space design apparatus according to claim 1, wherein
in the receiving from a user the object allocation operation, an operation for designating a type of the first object or a second object, which is a device constituting the plant, and a position in the virtual space to allocate the first object or the second object is received; and
in the allocating in response to the object allocation operation, the first object or the second object is allocated at the designated position.

3. The three-dimensional space design apparatus according to claim 2, wherein
the processing circuitry further executes:
receiving from a user an object edit operation for editing the first object or the second object allocated in the virtual space, and
allocating the edited first object or the edited second object in the virtual space.

4. The three-dimensional space design apparatus according to claim 3, wherein
in the receiving from a user the object edit operation, the editing includes receiving an input of a parameter set for the first object or the second object; and
in the allocating the edited first object or the edited second object, in response to an input of the parameter, the first object or the second object corresponding to the parameter is allocated in the virtual space.

5. The three-dimensional space design apparatus according to claim 4, wherein
in the allocating the edited first object or the edited second object, the edited first object or the edited second object is allocated in the virtual space based on the parameter and information of a preset functional requirement.

6. The three-dimensional space design apparatus according to claim 3, wherein
in the receiving from a user the object edit operation, the editing includes receiving an input operation to edit according to one or more of usability, operability, ease-of-construction, and accessibility of the device in the plant.

7. The three-dimensional space design apparatus according to claim 3, wherein
in the receiving from a user the object edit operation, the editing includes receiving an input operation to edit a length and an installed angle of a pipe preset for the first object.

8. The three-dimensional space design apparatus according to claim 7, wherein
the pipe preset for the first object includes an intake for fluid supplied to the pipe and/or an outlet for the fluid.

9. The three-dimensional space design apparatus according to claim 8, wherein
in the receiving from a user the object edit operation, the editing includes receiving an input operation for changing the intake or the outlet for the fluid in the pipe.

10. The three-dimensional space design apparatus according to claim 3, wherein
the first object includes one or a plurality of the devices.

11. The three-dimensional space design apparatus according to claim 10, wherein
a pipe is preset for each of the one or the plurality of the devices of the first object.

12. The three-dimensional space design apparatus according to claim 10, wherein
in the receiving from a user the object edit operation, the editing includes receiving an input operation for editing the number of the devices.

13. The three-dimensional space design apparatus according to claim 12, wherein
in a case where the number of the devices is more than one, a plurality of intakes or outlets allocated on each of the devices are integrated.

14. The three-dimensional space design apparatus according to claim 3, wherein
the device includes one or more of a pump, a heat exchanger, a filter, a valve, a piping member, an instrument, a heating furnace, a tower tank, an agitator, and other facilities used in a chemical plant.

15. The three-dimensional space design apparatus according to claim 14, wherein
one or a plurality of the valves are allocated on the pipe preset for the first object.

16. The three-dimensional space design apparatus according to claim 14, wherein
in the receiving from a user the object edit operation, in a case where the device is a pump, the editing includes receiving an edit input for editing a type of the pump.

17. The three-dimensional space design apparatus according to claim 14, wherein
in the receiving from a user the object edit operation, in a case where the device is a heat exchanger, the editing includes receiving an edit input for editing a type of the heat exchanger and/or a type of a layout for the heat exchanger.

18. The three-dimensional space design apparatus according to claim 14, wherein
in the receiving from a user the object edit operation, in a case where the device is a filter, the editing includes receiving an edit input for editing a type of the filter.

19. The three-dimensional space design apparatus according to claim 14, wherein
in the receiving from a user the object edit operation, in a case where the device is a valve, the editing includes receiving an edit input for editing a type of the valve and/or a type of an arrangement of the valve.

20. A method for executing processing relating to three-dimensional space design of a plant that is executed by a computer provided with a processing circuitry, the method comprising:
by the processing circuitry,
receiving from a user an object allocation operation for designating a position in a virtual space to place a first object, which is an object in which a pipe is preset for a device constituting the plant;
allocating the first object in the virtual space in response to the object allocation operation;
receiving a routing operation from a user; and
performing pipe routing for connection to an end of the pipe of the allocated first object in response to the routing operation.
